(19) United States
(12) Patent Application Publication
(10) Pub. No.: US 2008/0063857 A1
(43) Pub. Date: Mar. 13, 2008

(54) Sealable, biaxially oriented polyester film with hydrophilic coating

(76) Inventors: Matthias Konrad, Hofheim (DE); Herbert Peiffer, Mainz (DE); Gottfried Hilkert, Saulheim (DE)

Correspondence Address: PROPAT, L.L.C., 425-C SOUTH SHARON AMITY ROAD, CHARLOTTE, NC, 28211-2841, US

(21) Appl. No.: 11/754,385

(22) Filed: May 29, 2007

(30) Foreign Application Priority Data
May 31, 2006 (DE) 10 2006 025 281.0

(51) Int. Cl. B32B 27/36; B32B 27/20; B05D 7/00

(52) U.S. Cl. 428/323; 428/480; 428/349; 428/500; 428/339; 427/407.1

(57) ABSTRACT

The present invention relates to a polyester film which has a base layer (B), an outer layer (C), and a sealable outer layer (A), with antifog coating, where
a) the sealable outer layer (A) includes less than 0.01% by weight of external particles, and
b) the outer layer (C) includes from 0.12 to 0.4% by weight of external particles whose median diameter d₅₀ is from 2 to 5 μm and whose particle size distribution (SPAN98) is from 1.2 to 2.

The preferred polyester of the base layer (B) is PET, and the preferred polyester of the outer layer (A) is a copolyester having ethylene terephthalate units and ethylene isophthalate units.

### CROSS-REFERENCE TO RELATED APPLICATIONS

This application claims priority to German Patent Application 10 2006 025 281.0 filed May 31, 2006 which is hereby incorporated herein by reference in its entirety.

### FIELD OF THE INVENTION

The invention relates to a transparent, sealable, biaxially oriented polyester film comprising a base layer (B), a sealable outer layer (A), an antifog coating on this sealable layer (A), and a non-sealable outer layer (C). The invention further relates to a process for the production of the film and to its use.

Sealable, biaxially oriented polyester films are known in the prior art.

The packaging industry has a major requirement for transparent, biaxially oriented polyester films. When fresh, perishable foods are packed with polyester film, a possible result, especially in the case of cooled products, is undesired fogging of the film and therefore impairment of transparency, if moisture from the packed goods condenses on the film, mostly in the form of droplets of varying size. This condensation markedly impairs the transparency of the film. The reduction in transparency of the film can be countered by a hydrophilic coating, also termed an antifog coating.

GB-A-1 465 973 describes a coextruded, two-layer polyester film, one layer of which is comprised of isophthalic-acid-containing and terephthalic-acid-containing copolyesters and the other layer of which is comprised of polyethylene terephthalate. The specification gives no useful information concerning the sealing behavior of the film. Because of a lack of pigmentation, the film has only limited capability for winding and further processing.

EP-A-0 035 835 describes a coextruded, sealable polyester film where particles whose average particle size exceeds the thickness of the sealable layer are added in the sealable layer in order to improve winding behavior and processing behavior. The particulate additives form surface protrusions which inhibit the undesired blocking and sticking of the film to rolls or guides. No further information is given concerning incorporation of antiblocking agents in the other, non-sealable, layer of the film. It is uncertain whether said layer comprises antiblocking agents. Selection of particles whose diameter is greater than the thickness of the sealable layer and selection of the concentrations cited in the examples impairs the sealing behavior of the film. The seal seam is produced at 140° C., and seal seam strength is determined at 23° C., and is in the range from 63 to 120 N/m (corresponding to from 0.97 to 1.8 N/15 mm of film width).

EP-A-0 515 096 describes a coextruded, multilayer, sealable polyester film whose sealable layer has an additional additive. The additive can, for example, comprise inorganic particles, and is preferably applied in the form of an aqueous layer to the film during its production. The intention here is to retain the good sealing properties and give the film good processibility. The reverse side of the film comprises only very few particles, these mainly passing into this layer by way of regrind. Said specification gives no information concerning the sealing temperature range of the film. The seal seam is produced at 140° C. and seal seam strength is determined at 23° C., and is more than 200 N/m (corresponding to 3 N/15 mm of film width). For a sealable layer of thickness of 3 μm, a seal seam strength of 275 N/m is cited (corresponding to 4.125 N/15 mm of film width).

EP 0 920 381 B1 describes a coextruded, multilayer polyester film which has a sealable outer layer and a non-sealable base layer. The base layer here can be comprised of one or more layers, there being contact between one of the layers and the sealable layer. The other (exterior) layer then forms the second, non-sealable outer layer. The sealable outer layer can be comprised of isophthalic-acid-containing and terephthalic-acid-containing copolyesters. The film also comprises a UV absorber, the amount of which added to the base layer is from 0.1 to 10% by weight. The base layer of said film has conventional antiblocking agents. The film features good sealability, but does not have the desired processing behavior and has shortcomings in optical properties. For example, the haze of the film is cited as <75%.

EP-A-1 138 480 equivalent to U.S. Pat. No. 6,423,401B2 describes a biaxially oriented, sealable polyester film with a base layer (B), with a sealable outer layer (A), and with a further, non-sealable outer layer (C). The minimum sealing temperature of the sealable outer layer (A) is at most 110° C., its seal seam strength being at least 1.3 N/15 mm of film width. The topographies of the two outer layers (A) and (C) are characterized by certain features. This film is particularly suitable for use in flexible packaging, and specifically and particularly for use on high-speed packaging machinery. The film still has shortcomings in relation to handling and processing behavior.

EP-A-1 471 096 equivalent to US 2004213966A1, EP-A-1 471 097 equivalent to US 2005042441A1, EP-A-1 475 228 equivalent to US 2004213967A1, EP-A-1 475 229 equivalent to US 2005019559A1, EP-A-1 471 -094 equivalent to US 2004213968A1, and EP-A-1 471 098 equivalent to US 2004229060A1 describe heat-sealable polyester films with ABC structure which are peelable with respect to APET/CPET and which comprise, in order to establish the desired peel properties in the peelable and heat-sealable outer layer (A), either from about 2 to 10% by weight of inorganic or organic particles or else a polyester-incompatible polymer, e.g. a norbornene-ethylene copolymer.

U.S. Pat. No. 4,467,073 discloses a transparent antifog coating. The constitution comprises a) polyvinylpyrrolidone, polydimethylacrylamide, or a polyvinylpyrrolidone copolymer with an α-olefin, b) a polyisocyanate prepolymer, c) a surfactant, and d) an organic solvent. A disadvantage of said invention is the use of an organic solvent, specifically when the coating step is to be incorporated into film production (in-line). The use of an isocyanate for food-packaging applications is also hazardous, since carcinogenic primary amines can be produced.

U.S. Pat. No. 5,262,475 describes a hydrophilic composition which comprises polyvinylpyrrolidone, polyvinyl alcohol, and, as crosslinking agent, melamine, and a mineral acid or a strong organic acid. The coating solution can moreover comprise additives, such as chain extenders, foam regulators, or surfactants. The solids content of the coating is from 5 to 50%. Crosslinking to give hard clear layers requires temperatures of at least 75° C., the temperatures used in the examples being from 130 to 150° C. This makes these coatings unsuitable for in-line application to polyester films, since the components crosslink before the end of the drying or stretching process and the coating therefore tears and can thus lead to film break-offs. Another factor that makes the use of the coating appear unsuitable for flexible substrates is that the cross-linked coatings are described as hard.

No polyester films have been disclosed hitherto which have good sealability and good antifog properties.

### SUMMARY OF ADVANTAGEOUS EMBODIMENTS OF THE INVENTION

It was then an object of the present invention to provide a sealable, biaxially oriented, antifog polyester film which does not have the disadvantages of the films of the prior art and in particular features
improved sealability with respect to itself and with respect to substrates comprised in particular of APET, A/CPET, CPET,
improved winding,
improved processing behavior (low coefficient of friction),
improved optical properties (haze),
and good antifog action.

(APET=amorphous polyethylene terephthalate (PET); CPET=crystalline PET; A/CPET=two-layer laminate, for example in a ready-meal tray, APET inside, CPET outside)

A particular intention of the present invention was to provide a polyester film with good antifog effect and simultaneously with good sealing with respect to other (non-sealable) polyester films or trays (ready-meal trays) comprised of polyester.

The seal seam strength of the outer layer (A) of the polyester film with respect to itself (sealing temperature 180° C.) is preferably greater than 1.0 N/15 mm, in particular greater than 1.2 N/15 mm, and particularly preferably greater than 1.4 N/15 mm. With respect to an APET substrate, the minimum sealing temperature of the outer layer (A) of the polyester film is preferably to be less than 160° C., in particular less than 155° C., and particularly preferably less than 150° C., and the seal seam strength of the outer layer (A) of the polyester film with respect to an A/PET substrate (sealing temperature 180° C.) is preferably to be greater than 1.0 N/15 mm, in particular greater than 1.2 N/15 mm, and particularly preferably greater than 1.4 N/15 mm.

Care was also to be taken that the film has good windability and can be processed on high-speed machinery. During production of the film it should also be ensured that an amount which is preferably up to 60% by weight, based on the total weight of the film, of cut material arising in the form of regrind can be reintroduced to the production process, without any significant resultant adverse effect on the physical and optical properties of the film.

### BRIEF DESCRIPTION OF THE DRAWINGS

FIG. 1 is a cross-sectional schematic illustration of an exemplary film in accordance with the invention;

FIG. 2 is a graphical illustration of an exemplary particle size distribution curve illustrating the median particle diamerter, d₅₀;

FIG. 3 is a graphical illustration of an exemplary particle size distribution curve illustrating the d₁₀ and d₉₈ values used in determining the SPAN 98;

FIG. 4 is a schematic illustration of a tensile strain measuring technique; and

FIG. 5 schematically illustrates an exemplary contact angle of water on a film surface.

### DETAILED DESCRIPTION OF ADVANTAGEOUS EMBODIMENTS OF THE INVENTION

The invention achieves the object via provision of a transparent, biaxially oriented, sealable, antifog polyester film with a bass layer (B), with a sealable outer layer (A), with antifog coating, and with an outer layer (C), where
a) the sealable outer layer (A) comprises less than 0.01% by weight of external particles (based on the total weight of the outer layer (A),
b) the coating comprises, prior to application to the film, water and the following components:
   polyvinylpyrrolidone (=component i),
   a surfactant (=component ii), and optionally
   a polymer which improves the binding of the other components to the polyester surface (adhesion-promoting polymer=component iii), and
c) the non-sealable outer layer (C) comprises a pigment characterized via the following features:
   the median diameter of the particles (d₅₀ value) is in the range which is preferably from 2 to 5 μm,
   the scatter of the particle size distribution, expressed via the SPAN98, is in the range which is preferably from 1.2 to 2, and
   the concentration of the particles is in the range which is preferably from 0.12 to 0.40% by weight, based on the total weight of the outer layer(C).

The term pigments (also called particles here) also includes antiblocking agents, fillers, and external or inert particles which are characterized via the parameters mentioned. Typical pigments are inorganic and/or organic particles, e.g. calcium carbonate, amorphous silica, talc, magnesium carbonate, barium carbonate, calcium sulfate, barium sulfate, lithium phosphate, calcium phosphate, magnesium phosphate, aluminum oxide, LiF, the calcium, barium, zinc, or manganese salts of the dicarboxylic acids used, titanium dioxide, kaolin, or particulate polymers, e.g. crosslinked polystyrene particles or crosslinked acrylate particles.

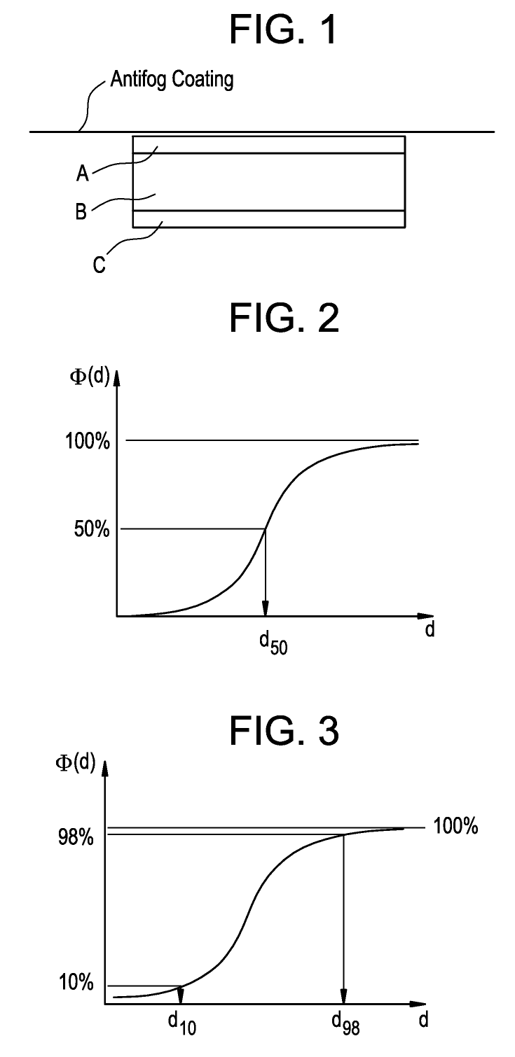

According to the invention, the film preferably has a three-layer structure and encompasses the base layer (B), the sealable and coated outer layer (A), and the non-sealable outer layer (C) (A-B-C, FIG. 1).

The haze of the transparent film is preferably smaller than 5%.

The sealable outer layer (A) preferably comprises less than 0.01% by weight (based on the total weight of the outer layer (A)) of external particles, and particularly preferably absolutely no external particles. This case gives the best sealing with respect to itself and with respect to the materials listed above. In this case no bubbles form between the sealable layer (A) and the substrate, and sealing occurs over the entire area. Otherwise, cavities form, caused by the peaks of the fillers, for example, and impair sealing.

It has been found that the d₅₀ particle diameter, the SPAN98 scatter, and the concentration of the pigments used in the non-sealable outer layer (C) are decisive for good winding, for good processibility, and for good optical properties of the film.

To achieve good winding and good processibility of the film, the outer layer (C) comprises a pigment whose median diameter (d₅₀ value) is in the range from 2 to 5 μm, preferably from 2.1 to 4.9 μm, and particularly preferably from 2.2 to 4.8 μm, and the SPAN98 is in the range from 1.2 to 2, preferably from 1.25 to 1.9, and particularly preferably from 1.3 to 1.8.

If, in contrast, the outer layer (C) comprises a pigment whose median diameter and/or SPAN98 is outside the inventive range, this has an adverse effect on winding, processibility, and the optical properties of the film.

If the outer layer (C) comprises a pigment whose median diameter is greater than 5 μm, filter behavior becomes impaired; if the SPAN98 is greater than 2, the optical properties and the winding of the film become poorer.

If the outer layer (C) of the film comprises, as sole pigment, a pigment whose median diameter is smaller than 2 μm, haze increases, and gloss becomes poorer; if the SPAN98 is smaller than 1.2, the winding of the film becomes poorer, and the film has a tendency toward “blocking”, for example.

In order to improve winding behavior and processibility, the outer layer (C) has a high level of inert, added pigments. The concentration of the inert particles in the outer layer (C) is preferably from 0.12 to 0.4% by weight, in particular from 0.14 to 0.35% by weight, and in the particularly preferred embodiment is from 0.16 to 0.3% by weight, depending in essence on the optical properties to be achieved in the film.

It is also possible (in addition) moreover to incorporate other pigments, e.g. with d₅₀ value smaller than that of the main pigment, into the outer layer (C). However, if the d₅₀ values and/or SPAN98 values of the main pigment deviate from the abovementioned values, or if no such pigment is present, the disadvantages described above arise (main pigment means the pigment with the greatest concentration in (C)).

A feature of the antifog coating on the outer layer (A) is that it comprises the following components, alongside water:

polyvinylpyrrolidone (=component i),
a surfactant (=component ii), and optionally
a polymer which improves the binding of the other components to the polyester surface (adhesion-promoting polymer=component iii).

The total concentration of all of the components i) to iii) in water is preferably in the range from 1 to 8% by weight. Unless otherwise stated, all of the amounts stated are percentages by weight, based on the weight of the ready-to-use coating preparation.

The molecular weight (M_{w}) of the polyvinylpyrrolidone used is preferably from 20 to 2500 kilodaltons, particularly preferably from 40 to 1500 kilodaltons. The content of the polyvinylpyrrolidone in the coating solution is mostly from 0.3 to 4.0% by weight, preferably from 0.5 to 3.5% by weight. If polyvinylpyrrolidone having lower molecular weights is used, the coating becomes more susceptible to removal by washing, and at higher molecular weights the coating solution becomes too viscous.

Surfactants are molecules comprised of a hydrophobic and a hydrophilic moiety, being described as amphiphilic.

The concentration used of the surfactant mentioned in the coating composition described above is from about 0.1 to 2.5% by weight, preferably from 0.3 to 2.0% by weight, and the surfactant is preferably ionic, particularly preferably anionic, and is particularly preferably selected from the group of the alkyl sulfates, alkylbenzene sulfates, alkyl ether sulfates, or sulfosuccinic esters or their salts.

The polymers which improve the binding of the polyvinylpyrrolidone to the polyester surface are preferably used in the form of an aqueous solution or dispersion. The concentration of these polymers in the finished coating solution is from about 0.3 to 4.0% by weight, preferably from 0.5 to 3.5% by weight. Suitable polymers of this type are acrylates, for example those described in WO 94/13476, hydrophilic polyesters (e.g. PET/IPA polyesters containing the sodium salt of 5-sulfoisophthalic acid, for example those described in EP-A-0 144 878 equivalent to U.S. Pat. No. 4,493,872A1, U.S. Pat. No. 4,252,885, or EP-A-0 296 620, dendritic polyesters having alcohol or acid end groups), polyurethanes, butadiene copolymers with acrylonitrile or methyl methacrylate, methacrylic acid, or an ester thereof.

The ready-to-use coating composition is therefore preferably comprised solely of water and of components i) and ii), or i), ii), and iii), and also, if appropriate, of antiblocking agents. “Comprised” here means that the composition is comprised of at least 90% by weight, preferably at least 95% by weight, and particularly preferably at least 99% by weight, of the components mentioned.

After in-line coating with the coating composition, the finished coating on the outer layer (A) is comprised of the dried residue (drying product) of the coating composition, which then equally preferably is comprised solely of the drying product of components i) and ii), or i), ii), and iii), and also, if appropriate, of antiblocking agents. The excess water or the excess solvent used has evaporated in the process.

Surprisingly, it has been found that the coating brings about not only the antifog effect but also a marked reduction in the coefficient of friction of the sealable layer (A) with respect to itself and with respect to the outer layer (C) of the film.

The base layer (B) and the outer layer (C) of the film are preferably comprised of at least 90% by weight of a thermoplastic polyester. Materials suitable for this purpose are polyesters comprised of ethylene glycol and terephthalic acid (=polyethylene terephthalate, PET), comprised of ethylene glycol and naphthalene-2,6-dicarboxylic acid (=polyethylene-2,6-naphthalate, PEN), comprised of 1,4-bishydroxymethylcyclohexane and terephthalic acid (=poly(1,4-cyclohexanedimethylene terephthalate, PCDT) or else comprised of ethylene glycol, naphthalene-2,6-dicarboxylic acid and biphenyl-4,4-dicarboxylic acid (=polyethylene-2,6-naphthalate bibenzoate, PENBB). Particular preference is given to polyesters comprised of at least 90 mol %, preferably at least 95 mol %, of ethylene glycol units and terephthalic acid units, or of ethylene glycol units and naphthalene-2,6-dicarboxylic acid units. The remaining monomer units derive from other aliphatic, cycloaliphatic, or aromatic diols and, respectively, dicarboxylic acids.

Other examples of suitable aliphatic diols are diethylene glycol, triethylene glycol, aliphatic glycols of the formula HO—(CH₂)ₙ—OH, where n is an integer from 3 to 6 (in particular 1,3-propanediol, 1,4-butanediol, 1,5-pentanediol and 1,6-hexanediol) and branched aliphatic glycols having up to 6 carbon atoms. Among the cycloaliphatic diols, mention should be made of cyclohexanediols (in particular 1,4-cyclohexane-diol). Examples of other suitable aromatic diols have the formula HO—C₆H₄-X-C₆H₄—OH, where X is —CH₂—, —C(CH₃)₂—, —C(CF₃)₂—, —O—, —S— or —SO₂—. Bisphenols of the formula HO—C₆H₄—C₆H₄—OH are very suitable.

One way of preparing the polyesters is the transesterification process. Here, the starting materials are dicarboxylic esters and diols, which are reacted using the customary transesterification catalysts, such as the salts of zinc, of calcium, of lithium, of magnesium or of manganese. The intermediates are then polycondensed in the presence of well-known polycondensation catalysts, such as antimony trioxide or titanium salts. Another equally good preparation method is the direct esterification process in the presence of polycondensation catalysts. This starts directly from the dicarboxylic acids and the diols. Inventive polyesters are commercially available.

The sealable outer layer (A) preferably applied via coextrusion to the base layer (B) is preferably in essence comprised of copolyesters which are mainly comprised of isophthalic acid units and of terephthalic acid units and of ethylene glycol units. The remaining monomer units derive from other aliphatic, cycloaliphatic, or aromatic diols and, respectively, dicarboxylic acids that can also occur in the base layer. The preferred copolyesters which provide the desired sealing properties are those comprised of ethylene terephthalate units and of ethylene isophthalate units. The proportion of ethylene terephthalate is preferably from 60 to 95 mol %, and the corresponding proportion of ethylene isophthalate is from 40 to 5 mol %. Preference is moreover given to copolyesters in which the proportion of ethylene terephthalate is from 65 to 90 mol % and the corresponding proportion of ethylene isophthalate is from 35 to 10 mol %, and great preference is given to copolyesters in which the proportion of ethylene terephthalate is from 70 to 85 mol % and the corresponding proportion of ethylene isophthalate is from 30 to 15 mol %.

The desired sealing properties of the outer layer (A) are believed to be obtained from the combination of the chemical constitution of the copolyester used, the thickness of the outer layer, the topography (smooth surface), and the hydrophilic coating.

The sealable outer layer (A) has
with respect to itself, a minimum sealing temperature which is preferably less than 150° C., and a seal seam strength (the seal seam being produced at 180° C. and seal seam strength being determined at 23° C.) which is preferably at least 1.0 N/15 mm of film width;
with respect to a substrate comprised of APET, a minimum sealing temperature which is preferably less than 16020 C., and a seal seam strength (the seal seam being produced at 180° C. and seal seam strength being determined at 23° C.) which is preferably at least 1.0 N/15 mm of film width.

The best sealing properties of the film are obtained when no further additives, in particular no inorganic or organic fillers, are added to the copolyester. This case give the lowest minimum sealing temperature and the highest seal seam strength for a given copolyester and a given layer thickness.

The base layer (B) can also comprise conventional additives, examples being UV stabilizers, hydrolysis stabilizers, antiblocking agents (e.g. by way of the regrind). The other outer layer (C) can likewise also comprise conventional additives, examples being stabilizers. These additives are advantageously added to the polymer or to the polymer mixture before melting begins. Examples of stabilizers advantageously used are phosphorus compounds, such as phosphoric acid or phosphoric esters.

The thickness of the outer layer (C) of the film is generally greater than 0.4 μm and is preferably in the range from 0.5 to 10 μm, in particular in the range from 0.8 to 9 μm, and particularly preferably in the range from 1.0 to 8 μm.

The thickness of the outer layer (A) of the film is generally greater than 0.4 μm and is preferably in the range from 0.5 to 10 μm, in particular in the range from 0.8 to 9 μm, and particularly preferably in the range from 1.0 to 8 μm.

The total thickness of the inventive polyester film can vary widely. It is preferably from 5 to 500 μm, in particular from 7 to 300 μm, with preference from 10 to 100 μm.

The invention also provides a process for production of the inventive polyester film by coextrusion methods known per se from the literature.

First, as is conventional in the coextrusion process, the polymers or the polymer mixtures for the individual layers are compressed and plasticized in an extruder, and the added materials intended, if appropriate, as additives here can be present in the polymer or in the polymer mixture by this stage. The melts are then simultaneously pressed through a flat-film die, and the extruded multilayer melt is drawn off on one or more take-off rolls, whereupon the melt cools and hardens to give an unoriented prefilm.

The biaxial orientation process is generally carried out sequentially. In this process, the prefilm is preferably first stretched longitudinally (i.e. in machine direction=MD) and then stretched transversely (i.e. perpendicularly to machine direction=TD). This results in spatial orientation of the polymer chains. The longitudinal stretching can be carried out with the aid of two rolls rotating at different speeds corresponding to the desired stretching ratio. The transverse stretching process generally uses an appropriate tenter frame in which the two edges of the film are clamped, the film then being subjected to tension in the direction of the two sides at an elevated temperature.

The temperature at which the stretching process is carried out can be varied relatively widely and depends on the desired properties of the film. The longitudinal stretching process will generally be carried out at a temperature in the range from 80 to 130° C. and the transverse stretching process will generally be carried out in the range from 90 to 150° C. The longitudinal stretching ratio is generally in the range from 2.5:1 to 6:1, preferably from 3.0:1 to 5.5:1. The transverse stretching ratio is generally in the range from 3.0:1 to 5.0:1, preferably from 3.5:1 to 4.5:1.

In the heat-setting process which follows, the film is kept at a temperature of from about 150 to 250° C. for a period of from about 0.1 to 10 s. The film is then wound up conventionally.

After the biaxial stretching process, it is preferable that the non-sealable surface of the film is corona—or flame-treated in accordance with one of the known methods. The intensity of treatment is generally in the range above 50 mN/M.

The inventive biaxially oriented polyester film is in-line coated on the sealable layer, and this means that the coating is preferably applied during the film-production process prior to longitudinal and/or transverse stretching. In order to achieve good wetting of the polyester film by the aqueous coating solution or aqueous coating dispersion, the surface is preferably first corona-treated. The coating can be applied by any familiar suitable process, for example using a slot coater or a spray method.

It is particularly preferable to apply the coating by means of reverse gravure-roll coating, which can apply the coating extremely homogeneously with application weights of from 1 to 5 g/m² (wet). Preference is likewise given to application via the Meyer rod method, which can achieve relatively high coating thicknesses. The thickness of the coating on the finished film is from about 5 to 500 nm, preferably from 30 to 200 nm.

The inventive film features excellent sealability, very good winding and optical properties, very good processing behavior, and very good antifog effect. The sealable outer layer (A) seals with respect to itself, with respect to the non-sealable outer layer (C), and with respect to substrates comprised, for example, of APET, A/CPET, and CPET. This makes the film useful in many sectors, for example as lid film for (ready-meal) trays, or for bags, or generally as packaging material for foods and other consumable items.

Alongside this, it has been ensured that, during production of the film, an amount in the range from about 20 to 60% by weight, based on the total weight of the film, of the cut material (regrind) can be reintroduced into the extrusion process without any significant resultant adverse effect on the physical and optical properties of the film, in particular on its appearance.

The tables below (tables 1 and 2) again collate the most important preferred properties of the film.

TABLE 1
(Antifog coating, rows 1–4 being based on the ready-to-use aqueous
coating composition; rows 5–6 being based on dried coating on
outer layer (A))

| | Preferred | Particularly | |
|---|---|---|---|
| Coating components | range | preferred | Unit |
| Polyvinylpyrrolidone, | 0.3–4.0 | 0.5–3.5 | % by wt. |
| proportion | | | |
| Polyvinylpyrrolidone, | 20–2500 | 40–1500 | kilodaltons |
| Mᵥ | | | |
| Surfactant, | 0.1–2.5 | 0.3–2.0 | % by wt. |
| proportion | | | |
| Optional polymer, | 0.3–4.0 | 0.5–3.5 | % by wt. |
| proportion | | | |
| Thickness of coating | 5–500 | 30–200 | nm |
| Contact angle α with | <20 | <15 | ° |
| respect to water | | | |

TABLE 2

| | | | Very | |
|---|---|---|---|---|
| | | Particularly | particularly | |
| | Preferred range | preferred | preferred | Unit |
| Outer layer (A) | | | | |
| Filler concentration | ≦0.01 | none | | % by wt. |
| Thickness of outer layer (A) | 0.5–10 | 0.8–9 | 1.0–8 | μm |
| Outer layer (C) | | | | |
| Filler concentration | 0.12–0.40 | 0.14–0.35 | 0.16–0.30 | % by wt. |
| Particle diameter d₅₀ | 2–5 | 2.1–4.9 | 2.2–4.8 | μm |
| SPAN98 | 1.2–2 | 1.25–1.9 | 1.3–1.8 | |
| Thickness of outer layer (C) | 0.5–10 | 0.8–9 | 1.0–8 | μm |
| Film properties | | | | |
| Film thickness | 5–500 | 7–300 | 10–100 | μm |
| Minimum sealing temperature of OL A with | 150 | 145 | 140 | ° C. |
| respect to itself (=FIN) | | | | |
| Seal seam strength of OL A with respect to | >1.0 | >1.2 | >1.4 | N/15 mm |
| itself (sealing temperature 180° C.) | | | | |
| Minimum sealing temperature of OL A with | 160 | 155 | 150 | ° C. |
| respect to APET substrate | | | | |
| Seal seam strength of OL A with respect to | >1.0 | >1.2 | >1.4 | N/15 mm |
| APET substrate (sealing temperature 180° C.) | | | | |
| Film haze | <5 | <4.5 | <4 | % |

OL: Outer layer

For the purposes of the present invention, the following test methods were used for characterization of the raw materials and of the films:

### Measurement of Contact Angle α

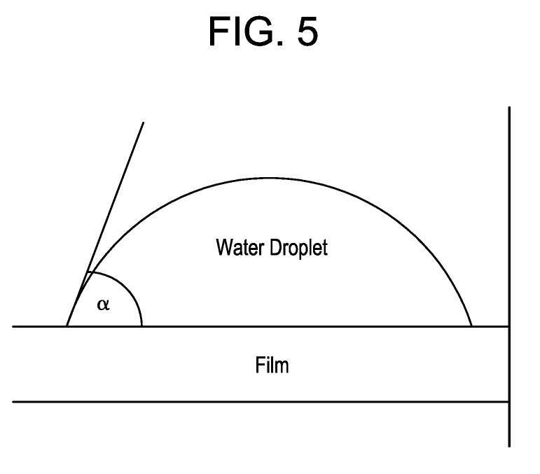

Contact angle α with respect to water (see FIG. 5) was measured and taken as a measure of the level of hydrophilic properties of the film surface. The smaller the contact angle α, the higher the level of hydrophilic properties of the film surface. The measurement was made on a G1 goniometer from Krüss, Hamburg, Del.

### Determination of Antifog Action

Antifog properties of the polyester films were determined as follows:

Film samples were welded onto a ready-meal tray (length about 17 cm, width about 12 cm, height about 3 cm) comprised of amorphous polyethylene terephthalate (=APET) and comprising about 50 ml of water, in a laboratory temperature-controlled to 23° C. with 50% relative humidity.

The trays were stored in a refrigerator temperature-controlled to 4° C. and removed for assessment after, respectively, 10 min, 30 min, 4 h, 8 h, and 24 h. The test assessed condensation resulting when air at 23° C. was cooled to refrigerator temperature. A film equipped with effective antifog agent is transparent even after condensation has occurred, since, for example, the condensate forms a coherent, transparent film. Without effective antifog agent, formation of a fine mist of droplets on the film surface leads to reduced transparency of the film; in the most disadvantageous case the contents of the ready-meal tray become invisible.

Another test method is known as the hot-fog test. For this, a 250 ml glass beaker containing 50 ml of water and covered by the film to be tested is placed in a water bath temperature-controlled to 70° C. The assessment is identical with that described above. In addition, this test can test long-term antifog action and, respectively, leaching resistance of the film, since steam continuously condenses on the film and then runs off or drips off. The result is leaching of readily soluble substances and decreased antifog action. This test was likewise carried out in a laboratory temperature-controlled to 23° C. with 50% relative humidity.

### Measurement of Median Particle Diameter d₅₀

Median particle diameter d₅₀ was determined by laser on a Master Sizer (Malvern Instruments, UK) by the standard method (examples of other test equipment being the Horiba LA 500 (Horiba Ltd., Japan) or Helos (Sympatec GmbH, Germany), which use the same principle of measurement). For this, the specimens were placed in a cell with water and this was then inserted into the test equipment. The test procedure is automatic, and also includes the mathematical determination of the d₅₀ value. The d₅₀ value is determined here in accordance with its definition from the (relative) cumulative particle size distribution curve: the point of intersection of the 50% by weight ordinate value with the cumulative curve gives the desired d₅₀ value (cf. FIG. 2) on the abscissa axis.

### Measurement of SPAN98

The test equipment used to determine SPAN98 was the same as that described above for the determination of median diameter d₅₀. SPAN98 is defined here as follows:

$$SPAN 98 = \frac{{d}_{98} - {d}_{10}}{{d}_{00}}$$

Determination of d₉₈ and d₁₀ is in turn based on the cumulative particle size distribution curve. The point of intersection of the 98% ordinate value with the cumulative curve gives the desired d₉₈ value on the abscissa axis, and the point of intersection of the 10% ordinate value with the cumulative curve gives the desired d₁₀ value on the abscissa axis (cf. FIG. 3).

### Seal Seam Strength (with Respect to APET)

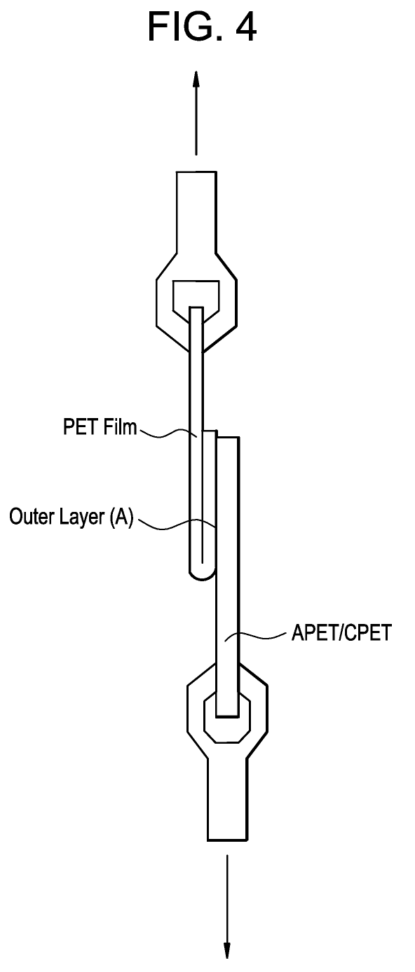

To determine seal seam strength, a strip of film (length 100 mm×width 15 mm) is placed on the APET side of a corresponding strip of a ready-meal tray and sealed with a sealing time of 0.5 s and a sealing pressure of about 3 bar (HSG/ET sealing equipment from Brugger, Germany, bilaterally heated sealing jaws) with the temperature set at 180° C. As in FIG. 4, the sealed strips are clamped into the tensile test machine (e.g. TC˜FR1.0TH.D09 universal test machine from Zwick, Germany) and the 180° seal seam strength was determined, this being the force needed to separate the test strips using a separation velocity of 200 mm/min and a test temperature of 23° C. The seal seam strength is stated in N per 15 mm of film strip (e.g. 2 N/15 mm).

### Determination of Minimum Sealing Temperature (With Respect to APET)

Heat-sealed specimens (seal seam 15 mm×100 mm) are produced as described above under measurement of seal seam strength using Brugger HSG/ET sealing equipment, by sealing the film at different temperatures with the aid of two heated sealing jaws at a sealing pressure of 3 bar and with a sealing time of 0.5 s. Seal seam strength was measured as in the determination of 180° seal seam strength. The minimum sealing temperature is the temperature at which a seal seam strength of at least 0.5 N/15 mm is achieved.

Seal seam strength with respect to itself (=FIN sealing)

To determine seal seam strength, two film strips of width 15 mm were mutually superposed and sealed with a sealing time of 0.5 s and a sealing pressure of 3 bar (equipment; Brugger NDS, single-side heated sealing jaws) at 180° C. The seal seam strength was determined by the T-Peel method=2·90°).

### Determination of Minimum Sealing Temperature With Respect to Itself

HSG/ET sealing equipment from Brugger was used to produce heat-sealed specimens (seal seam 20 mm×100 mm), where the film is sealed with a sealing time of 0.5 s and at a sealing pressure of 3 bar with the aid of two heated sealing jaws at various temperatures. Test strips of width 15 mm were cut from the sealed specimens. T-seal seam strength was measured as in the determination of seal seam strength. The minimum sealing temperature is the temperature at which a seal seam strength of at least 0.5 N/15 mm is achieved.

### Haze

Haze is determined to ASTM D1003-52.

### SV Value (Standard Viscosity)

Standard viscosity SV (DCA) is measured by a method based on DIN 53726 at 25° C. in dichloroacetic acid. The intrinsic viscosity (IV, measured in dl/g) of polyethylene terephthalate is calculated as follows from the standard viscosity

rV=[n]=6.907·10⁻⁴ SV(DCA)+0.063096 [dl/g]

### EXAMPLE 1

The following components were dissolved in water to produce the coating solution:
1.5% by weight of polyvinylpyrrolidone (LUVITEC® K30; BASF AG, M_{w}˜50 kilodaltons)
1.5% by weight of the sodium salt of diethylhexyl sulfosuccinate (LUTENSIT® A-BO; BASF AG)
(% by weight data here being based on the finished coating solution).

This coating solution was applied to the coextruded polyester film by the following method:

### A multilayer polyester melt was produced and this was extruded through a flat-film die onto a casting roll maintained at about 20° C., where it solidified to give an unoriented film.

The coextruded polyester film comprised the following layers and raw materials:

Outer layer (A) 100% by weight of copolyester comprised of 78 mol % of ethylene terephthalate and 22 mol % of ethylene isophthalate whose SV value was 800

Base layer (B) 100% by weight of polyethylene terephthalate whose SV value was 800

Outer layer (C) mixture comprised of 80% by weight of polyethylene terephthalate whose SV value was 800 and 20% by weight of masterbatch comprised of 99% by weight of polyethylene terephthalate (SV value 800) and 1.0% by weight of SYLOBLOC® 44 H (synthetic SiO₂ from Grace, d₅₀; 2.5 μm, SPAN98: 1.8)

The unoriented film was stretched longitudinally with a stretching ratio of 3.8:1, and was kept here at a temperature of 115° C. The longitudinally stretched film was coated on the outer layer (A) by reverse gravure coating with the solution described above comprised of polyvinylpyrrolidone and the sodium salt of diethylhexyl sulfosuccinate. The longitudinally stretched, coated film was dried at a temperature of 100° C. The film was then transversely stretched with a stretching ratio of 3.8:1, thus giving a biaxially stretched film. The biaxially stretched film was heat-set at 230° C. The final film thickness was 25 μm, the thickness of each of the outer layers here being 2 μm. The dry weight of the coating was about 0.04 g/m².

The film exhibited very good antifog properties, i.e. no formation of fine droplets was observed. The contact angle measured was α=12°, contrasting with an uncoated film with an angle of α=64°. There was no change to the transparency and the haze of the film during the antifog test.

### EXAMPLE 2

In contrast to Example 1, the thickness of the sealable outer layer (A) was raised from 2.0 to 3.0 μm, but the film structure and method of production were otherwise identical. The result was an improvement in sealing properties, in particular a marked increase in seal seam strength. As in Example 1, this film, too, exhibited very good antifog properties.

### EXAMPLE 3

In contrast with Example 1, the following constitution was now used for the coating solution:
1.0% by weight of polyvinylpyrrolidone (LUVITEC® k30; BASF AG, M_{w}˜50 kilodaltons)
1.0% by weight of an acrylate copolymer comprised of 60% by weight methyl methacrylate, 35% by weight of ethyl acrylate, and 5% by weight of N-methylolacrylamide
2.0% by weight of the sodium salt of diethylhexyl sulfosuccinate (LUTENSIT® A-BO; BASF AG).

The dry weight of the coating was about 0.05 g/m².

As in Example 1, this film too, exhibited very good antifog properties, with simultaneous reduction in the susceptibility of the coatings for removal by washing, meaning that the antifog properties were retained even after treatment with steam for a number of hours. The contact angle measured was α=11°, contrasting with an uncoated film with an angle of α=64°. There was no change in the transparency and the haze of the film during the antifog test.

### COMPARATIVE EXAMPLE 1

In contrast to Example 1, the level of pigmentation in the sealable outer layer (A) was now as high as in the non-sealable outer layer (C). This measure gave a marginal improvement in the winding of the film and its processing properties, but there was marked impairment of the sealing properties of the film and its optical properties.

### COMPARATIVE EXAMPLE 2

By analogy with Example 1, a biaxially oriented polyester film was produced, but without coating. Omission of the coating resulted in a rise in the coefficient of friction in the film.

The film exhibited marked droplet formation in the antifog test, i.e. the film had no antifog effect.

The most important properties of the films thus prepared are summarized in table 3 below:

TABLE 3

| | | | | | Comparative | Comparative |
|---|---|---|---|---|---|---|
| | | Example 1 | Example 2 | Example 3 | Example 1 | Example 2 |
| Thickness of outer layer | | 2 | 3 | 2 | 2 | 2 |
| (A) (μm) | | | | | | |
| Components | PVP (%) | 1.5 | 1.5 | 1.0 | 1.5 | — |
| of | Surfactant | 1.5 | 1.5 | 1.0 | 1.5 | — |
| coating | (%) | | | | | |
| | Acrylate | — | — | 2.0 | — | — |
| | (%) | | | | | |

| | | | | | |
|---|---|---|---|---|---|
| Dry weight of coating | 0.04 | 0.04 | 0.05 | 0.04 | — |
| (g/m²) | | | | | |
| Minimum sealing | 149 | 146 | 147 | 165 | 139 |
| temperature with respect | | | | | |
| to APET (° C.) | | | | | |
| Seal seam strength with | 3.8 | 4.5 | 4.0 | 1.0 | 5.3 |
| respect to APET at | | | | | |
| 180° C. (N/15 mm) | | | | | |
| Haze | 1.9 | 1.8 | 2.0 | 5.5 | 1.9 |
| Processing behavior | very | very | very | very | poor |
| | good | good | good | good | |
| Contact angle α with | 12 | 12 | 11 | 11 | 64 |
| respect to water | | | | | |

1. A polyester film comprising a base layer (B), an outer layer (C), a sealable outer layer (A), and an antifog coating, where
a) the sealable outer layer (A) comprises less than 0.01% by weight of external particles, and
b) the outer layer (C) comprises from 0.12 to 0.4% by weight of external particles whose median diameter d₅₀ is from 2 to 5 μm and whose particle size distribution (SPAN98) is from 1.2 to 2.

2. The polyester film as claimed in claim 1, which has an (A)-(B)-(C) layer structure, wherein the outer layer (A) has been provided with an antifog coating.

3. The polyester film as claimed in claim 1, wherein the outer layer (A) comprises no external particles.

4. The polyester film as claimed in claim 1, wherein the base layer (B) comprises a thermoplastic polyester.

5. The polyester film as claimed in claim 4, wherein the polyester of the base layer (B) has at least 90 mol % of ethylene glycol units and terephthalic acid units or ethylene glycol units and naphthalene-2,6-dicarboxylic acid units.

6. The polyester film as claimed in claim 4, wherein the polyester of the base layer (B) is polyethylene terephthalate.

7. The polyester film as claimed in claim 1, wherein the sealable outer layer (A) comprises a copolyester which as ethylene terephthalate units and ethylene isophthalate units.

8. The polyester film as claimed in claim 7, wherein the copolyester of the sealable outer layer (A) has from 60 to 95 mol % of ethylene terephthalate units and from 40 to 5 mol % of ethylene isophthalate units.

9. The polyester film as claimed in claim 1, wherein the outer layer (C) comprises SiO₂ as external particles.

10. The polyester film as claimed in claim 2, wherein the antifog coating on the outer layer (A) is derived from a coating composition comprising water, polyvinylpyrrolidone, a surfactant, and optionally an adhesion-promoting polymer.

11. The polyester film as claimed in claim 10, wherein the surfactant of the coating composition is a sulfosuccinic ester or its salt and the adhesion-promoting polymer is an acrylate.

12. The polyester film as claimed in claim 1, said film exhibiting a haze value of smaller than 5%.

13. The polyester film as claimed in claim 1, wherein said film exhibits a minimum sealing temperature of the outer layer (A) with respect to an APET substrate of less than 160° C.

14. The polyester film as claimed in claim 1, wherein said film exhibits a seal seam strength of the outer layer (A) with respect to an APET substrate of greater than 1 N/15 mm, at a sealing temperature of 180° C.

15. The polyester film as claimed in claim 1, wherein said film exhibits a contact angle with respect to water for the coated outer layer (A) of less than 20°.

16. The polyester film as claimed in claim 1, wherein the thickness of the outer layer (A) is from 0.5 to 10 μm.

17. A process for producing a polyester film as claimed in claim 1, comprising the steps of
a) producing a multilayer film via coextrusion,
b) longitudinally and transversely stretching the coextruded film,
c) heat-setting the stretched film, and
d) coating of the heat-set film with an antifog coating, either prior to the longitudinal stretching or after the longitudinal stretching and prior to the transverse stretching.

18. Packaging material for foods or other consumable items comprising polyester film as claimed in claim 1.

19. Lid film for containers for food or drink comprising polyester film as claimed in claim 1.
